(19) United States
(12) Patent Application Publication
(10) Pub. No.: US 2020/0371882 A1
(43) Pub. Date: Nov. 26, 2020

(54) Method, Apparatus, Device and Medium for Starting Virtual Machine

(71) Applicant: Beijing Baidu Netcom Science and Technology Co., Ltd., Beijing (CN)

(72) Inventors: Yongji Xie, Beijing (CN); Wen Chai, Beijing (CN); Yu Zhang, Beijing (CN)

(21) Appl. No.: 16/707,248

(22) Filed: Dec. 9, 2019

(30) Foreign Application Priority Data
May 24, 2019 (CN) 201910438528.X

(51) Int. Cl. G06F 11/14; G06F 9/455

(52) U.S. Cl. CPC G06F 11/1484; G06F 11/1469; G06F 11/1451; G06F 2009/45583; G06F 2009/45575; G06F 2201/84; G06F 2009/45591; G06F 9/45558

(57) ABSTRACT

A method, an apparatus, a device, and a computer readable storage medium for starting a virtual machine are provided. The method includes generating a disk snapshot for a first piece of data on a virtual disk of a first virtual machine. The method further includes starting running a second virtual machine based on identifier information of the first virtual machine and address information of the disk snapshot, such that the first piece of data is copied to a virtual disk of the second virtual machine. The method further includes pausing running the second virtual machine, in response to initialization of an operating system on the started second virtual machine being completed, for restoring the first virtual machine when the first virtual machine is unavailable.

### CROSS-REFERENCE TO RELATED APPLICATION

This application claims priority to Chinese Patent Application No. 201910438528.X filed May 24, 2019, the disclosure of which is hereby incorporated by reference in its entirety.

### TECHNICAL FIELD

Embodiments of the present disclosure mainly relate to the field of computers, and more particularly to a method, apparatus, device, and computer readable storage medium for starting a virtual machine.

### BACKGROUND

With the development of cloud computing, more and more Internet services are deployed on cloud. By deploying the services on cloud, users do not need to configure many devices, thereby reducing the user costs. In addition, by running these services in virtual machines on cloud, the running efficiency of the services can be improved. These services deployed on cloud are often started along with the start of the virtual machines on cloud for cost reasons.

However, some services running in a cloud platform have very high requirements on performance parameters. Thus, these services running in a server of the cloud platform also puts forward higher requirements on the server in the cloud platform. The existing virtual machine running mechanism cannot meet these requirements, thereby resulting in low efficiency and slow speed of providing the services, or even failure to provide corresponding services.

### SUMMARY

According to example embodiments of the present disclosure, a scheme for starting a virtual machine is provided.

In a first aspect of the present disclosure, a method for starting a virtual machine is provided. The method includes generating a disk snapshot for a first piece of data on a virtual disk of a first virtual machine; starting running a second virtual machine based on identifier information of the first virtual machine and address information of the disk snapshot, such that the first piece of data is copied to a virtual disk of the second virtual machine; and pausing running the second virtual machine, in response to initialization of an operating system on the started second virtual machine being completed, for restoring the first virtual machine when the first virtual machine is unavailable.

In a second aspect of the present disclosure, an apparatus for starting a virtual machine is provided. The apparatus includes a first disk snapshot generating module configured to generate a disk snapshot for a first piece of data on a virtual disk of a first virtual machine; a virtual machine starting module configured to start running a second virtual machine based on identifier information of the first virtual machine and address information of the disk snapshot, such that the first piece of data is copied to a virtual disk of the second virtual machine; and a first pausing module configured to pause running the second virtual machine, in response to initialization of an operating system on the started second virtual machine being completed, for restoring the first virtual machine when the first virtual machine is unavailable.

In a third aspect of the present disclosure, an electronic device is provided, including one or more processors, and a storage apparatus for storing one or more programs, wherein the one or more programs, when executed by the one or more processors, cause the one or more processors to implement the method according to the first aspect of the disclosure.

In a fourth aspect of the present disclosure, a computer readable storage medium is provided, storing a computer program thereon, where the program, when executed by a processor, implements the method according to the first aspect of the disclosure.

It should be understood that the content described in the summary section of the disclosure is not intended to limit the key or important features of the embodiments of the present disclosure, nor is it intended to limit the scope of the present disclosure. Other features of the present disclosure will become easily understood by the following description.

### BRIEF DESCRIPTION OF THE DRAWINGS

In conjunction with the accompanying drawings and with reference to detailed descriptions below, the above and other features, advantages, and aspects of various embodiments of the present disclosure will become more apparent. Identical or similar reference numerals in the accompanying drawings represent identical or similar elements.

FIG. 1 shows a schematic diagram of an example environment 100 of starting a virtual machine according to embodiments of the present disclosure;

FIG. 2 shows a flowchart of a method 200 for starting a virtual machine according to an embodiment of the present disclosure;

FIG. 3 shows a flowchart of a method 300 for restoring a virtual machine according to an embodiment of the present disclosure;

FIG. 4 shows a schematic block diagram of an apparatus 400 for starting a virtual machine according to an embodiment of the present disclosure; and

FIG. 5 shows a block diagram of a computing device 500 that can implement a plurality of embodiments of the present disclosure.

### DETAILED DESCRIPTION OF EMBODIMENTS

Embodiments of the present disclosure will be described below in more detail with reference to the accompanying drawings. Some embodiments of the present disclosure are shown in the accompanying drawings. However, it should be understood that the present disclosure may be implemented in various forms, and should not be construed as being limited to the embodiments set forth herein. On the contrary, these embodiments are provided to more thoroughly and completely understand the present disclosure. It should be understood that the accompanying drawings and embodiments of the present disclosure merely play an exemplary role, and are not intended to limit the scope of protection of the present disclosure.

In the description of the embodiments of the present disclosure, the term “including” and similar wordings thereof should be construed as open-ended inclusions, i.e., “including but not limited to.” The term “based on” should be construed as “at least partially based on.” The term “an embodiment” or “the embodiment” should be construed as “at least one embodiment.” The terms, such as “first,” and “second,” may refer to different or identical objects. Other explicit and implicit definitions may be further included below.

Generally, a virtual machine is quickly started mainly by generating a mirror file of the virtual machine through a snapshot. The snapshot is usually generated for data on a virtual memory and/or virtual disk of the virtual machine, e.g., a disk snapshot generated based on a virtual machine disk, or a memory snapshot generated based on the virtual memory. Then, the mirror file is directly loaded when the virtual machine is started each time. Thus, the virtual machine directly restores to a snapshot state, skips a boot process of BIOS and kernel of the virtual machine, and accelerates the starting speed. However, starting the virtual machine by loading a snapshot file still has defects, i.e., it is necessary to read and write the snapshot file on the disk when the virtual machine starts, and when the virtual machine has a large memory or slow disk speed, a duration of reading the snapshot file becomes a bottleneck of the starting duration.

According to some embodiments of the present disclosure, an improved scheme of starting a virtual machine is presented. In this scheme, a disk snapshot of a first virtual machine is generated to automatically generate a second virtual machine (which may also be referred to as a template virtual machine) corresponding to the first virtual machine. Then, running of the second virtual machine is started. Running of the second virtual machine is paused after completing initialization of an operating system of the second virtual machine. Based on the obtained second virtual machine, for restoring the first virtual machine, the second virtual machine may be directly used as a to-be-restored first virtual machine. In this case, the second virtual machine is started by preloading the virtual machine without the need for reloading disk data and memory data, thus accelerating the speed of restoring the virtual machine, reducing the duration of restoring the virtual machine, and improving the use efficiency of the virtual machine.

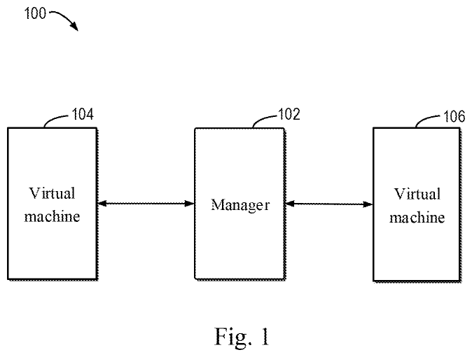

FIG. 1 shows a schematic diagram of an example environment 100 of starting a virtual machine according to embodiments of the present disclosure. The example environment 100 includes a manager 102. The manager 102 is configured to manage running of the virtual machine. The manager 102 may be a storage system controller, or a processor of a standalone computing device, or any other suitable device capable of managing running of the virtual machine. The above examples are merely used for describing some embodiments of the present disclosure, rather than specifically limiting the present disclosure.

FIG. 1 shows the manager 102 managing a first virtual machine 104 and a second virtual machine 106. Those skilled in the art should note that the virtual machine 104 and the virtual machine 106 in FIG. 1 are merely examples, rather than specifically limiting the present disclosure. The manager 102 may manage any number of virtual machines as required.

The virtual machine 104 refers to an application execution environment created by a specific application program on a hardware platform of a physical machine. A user may run an application through the environment and interact with the application, just like using the physical machine. When creating a virtual machine, the manager 102 usually needs to allocate a certain number of resources from a host system hosting the virtual machine, for use by the virtual machine 104 during operation. The resource may be any available resource for running the virtual machine, for example, a computing resource (e.g., a CPU, a GPU, or a FPGA), a storage resource (e.g., a memory, or a storage disk), and a network resource (e.g., a network card). The manager 102 will allocate various resources for the virtual machine 104, such as the memory and a disk.

When a disk snapshot is generated for the virtual machine 104, the virtual machine 106 is generated by the manager 102 based on the disk snapshot. The disk snapshot is a mirror file of data within a disk of the virtual machine. The generated disk snapshot is stored at a preset storage position, e.g., on the storage disk of a host running the virtual machine. The virtual machine 106 may alternatively be referred to as a template virtual machine of the virtual machine 104. When generating the disk snapshot for the virtual machine 104, the manager 102 obtains identifier information of the virtual machine 104 and address information of the disk snapshot. Then, configuration information of the virtual machine 104 may be determined based on the identifier information. The virtual machine 106 is started based on the identifier information and the address information. The started virtual machine 106 stores disk data related to the disk snapshot into the disk of the virtual machine.

In some embodiments, a storage capacity of a memory of the virtual machine 106 is different from a storage capacity of a memory of the virtual machine 104. In some embodiments, the storage capacity of the memory of the virtual machine 106 is less than the storage capacity of the memory of the virtual machine 104. In an example, a size of the storage capacity of the memory of the virtual machine 106 is merely adapted to start an operating system thereof. In an example, a size of the memory of the virtual machine 106 is 512M. The above examples are merely used for describing some embodiments of the present disclosure, rather than specifically limiting the present disclosure. Those skilled in the art may set the size of the memory of the virtual machine 106 as any appropriate value as required.

The virtual machine 106 may be started by the manager 102 based on the generated disk snapshot of the virtual machine 104. After running the operating system of the virtual machine 106, the manager 102 pauses running the virtual machine 106. By pausing running the virtual machine 106, computing resources making the virtual machine 106 continuously run can be reduced. When a request for restoring the virtual machine 104 is received, the paused virtual machine 106 may be re-run, to achieve quickly restoring the virtual machine 104. For example, after turning off the virtual machine 104, and after receiving the request for restoring the virtual machine 104, the manager 102 re-runs the virtual machine 106 for use as the restored virtual machine 104.

In some embodiments, when a plurality of snapshots of the virtual machine 104 are generated, virtual machines generated for prior snapshots are turned off, and only a virtual machine generated for the last snapshot is retained.

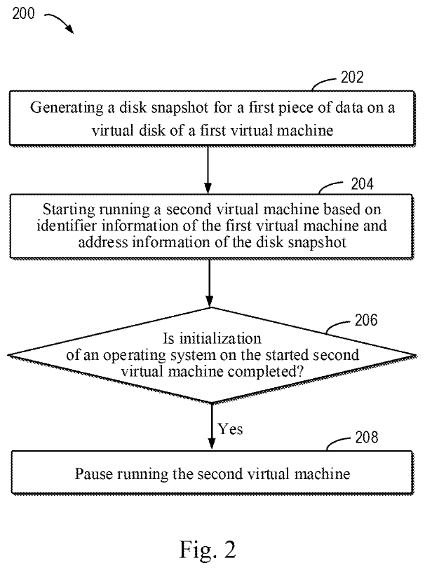

The above FIG. 1 shows the schematic diagram of the example environment 100 of starting a virtual machine according to embodiments of the present disclosure. A flowchart of a method 200 for starting a virtual machine according to an embodiment of the present disclosure will be described below in conjunction with FIG. 2. The method 200 may be implemented by the manager 102 in FIG. 1. For the ease of discussion, the method 200 will be described with reference to FIG. 1. It should be understood that while shown in a particular sequence, some steps of the method 200 may be performed in a sequence different from the shown sequence or be performed in parallel. Some embodiments of the present disclosure are not limited in this respect. In addition, the method 200 described in conjunction with FIG. 1 is merely an example, rather than specifically limiting the method 200.

In block 202, the manager 102 generates a disk snapshot for a first piece of data on a virtual disk of the virtual machine 104 (which may also be referred to as a first virtual machine below, for the convenience of description). The disk snapshot is a mirror file of data within the disk of the virtual machine. The generated disk snapshot is stored at a preset storage position, e.g., on the storage disk of a host running the virtual machine. In some embodiments, the manager 102 generates the disk snapshot merely for the first piece of data on the virtual disk of the first virtual machine. Alternatively or additionally, the manager 102 does not generate a corresponding snapshot for data on a memory of the first virtual machine.

A timing of generating the disk snapshot for data on the virtual disk of the first virtual machine by the manager 102 is also set as required. In some embodiments, the manager 102 generates the disk snapshot when receiving a request for generating a disk snapshot for the first virtual machine from a user. In some embodiments, the disk snapshot for the data on the disk of the virtual machine may be generated when the first virtual machine is available. In an example, if the manager 102 detects the first virtual machine to be turned off, the manager 102 generates the disk snapshot for the virtual disk of the first virtual machine. The above examples are merely used for describing some embodiments of the present disclosure, rather than specifically limiting the present disclosure.

In block 204, the manager 102 starts the virtual machine 106 (which may also be referred to as a second virtual machine, for the convenience of description) based on identifier information of the first virtual machine and address information of the disk snapshot, such that the first piece of data is copied to the virtual disk of the second virtual machine. The address information of the disk snapshot indicates a storage position of the generated disk snapshot. The manager 102 starts the second virtual machine based on the disk snapshot when determining that the disk snapshot of the first virtual machine is generated. In the process, the manager 102 determines an identifier of the first virtual machine and an address of the generated disk snapshot, and then transfer these two pieces of data to a virtual machine starting program, to generate the second virtual machine corresponding to the first virtual machine. Configuration of the second virtual machine is the same as configuration of the first virtual machine except for the memory.

In some embodiments, a first storage capacity of a first memory of the first virtual machine is greater than a second storage capacity of a second memory of the second virtual machine. In an example, the size of the storage capacity of the memory of the second virtual machine is merely adapted to start an operating system of the second virtual machine. In an example, the size of the memory of the second virtual machine is 512M. The above examples are merely used for describing some embodiments of the present disclosure, rather than specifically limiting the present disclosure. Because the virtual machine is resident in the memory, configuration of the memory thereof is minimized to reduce occupancy of the memory resource. Those skilled in the art may set the size of the memory of the second virtual machine as any appropriate value as required.

The second virtual machine further stores data from the virtual disk of the first virtual machine to a storage disk of the second virtual machine based on the address information of the disk snapshot, such that disk data of the second virtual machine is consistent with disk data of the first virtual machine when the first virtual machine generates a snapshot. Thus, in this case, the disk data of the second virtual machine is restored to a state of the first virtual machine that is generating the disk snapshot.

In block 206, the manager 102 determines whether initialization of an operating system on the started second virtual machine is completed. If initialization of the operating system on the started second virtual machine being completed is determined, in block 208, the manager 102 pauses running the second virtual machine, for restoring the first virtual machine when the first virtual machine is unavailable. After starting the second virtual machine, the manager 102 waits for the second virtual machine to complete initialization of the operating system. Running of the second virtual machine is paused after completing initialization of the operating system. After the first virtual machine is unavailable, the paused second virtual machine may be used as the first virtual machine to run various deployed services, when receiving a request for restoring the first virtual machine.

In some embodiments, the manager 102 pauses running the second virtual machine, in response to receiving indication information indicating completing initialization of the operating system from the second virtual machine. In an example, the manager 102 deploys a preset service within the second virtual machine. Automatic running of the service is started, when initialization of the operating system on the second virtual machine is completed. When run, the service sends the indication information to the manager 102 to indicate completing initialization of the operating system. In this case, the manager 102 may determine the operating system completing the initialization process based on the indication information.

In some embodiments, the manager 102 may monitor the started second virtual machine. When detecting the second virtual machine executing a preset access operation, then the initialization process of the operating system is completed. The preset access operation may be one or more predefined access operations, for example, a read operation, a write operation, or the like on a network adapter, a memory, or the like. In an example, the manager 102 detects the second virtual machine performing an access operation on the network adapter (such as a network card), indicating the initialization process being completed. In another example, the manager 102 detects the second virtual machine performing the access operation on a preset storage position. The above examples are merely used for describing some embodiments of the present disclosure, rather than specifically limiting the present disclosure. Those skilled in the art may provide any appropriate access operation, detectable by the manager, used for indicating initialization of the operating system of the second virtual machine being completed. Running of the second virtual machine may be paused, after determining detection of the second virtual machine performing the access operation on a specific component or a storage position. It should be understood that the above examples are merely used for describing some embodiments of the present disclosure, rather than specifically limiting the present disclosure.

When generating the disk snapshot of the first virtual machine, the second virtual machine (which may also be referred to as a template virtual machine) corresponding to the first virtual machine is automatically generated based on the disk snapshot. Then, the second virtual machine is paused and resident in the memory, such that when restoring the first virtual machine, running of the second virtual machine may be directly restored for use as a to-be-restored first virtual machine. The virtual machine is restored by such approach of preloading the virtual machine without the need for reloading the disk data and memory data, thus accelerating the speed of restoring the virtual machine, reducing the duration of restoring the virtual machine, and improving the use efficiency of the virtual machine.

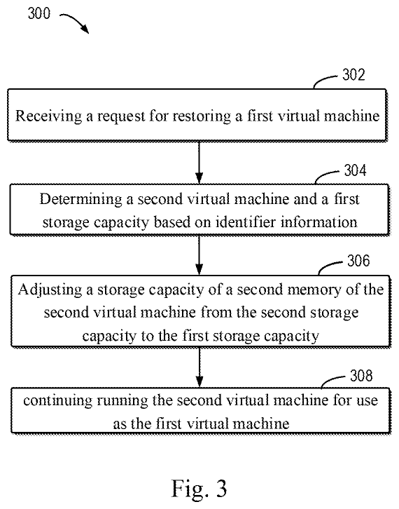

The flowchart of the method 200 for starting a virtual machine according to an embodiment of the present disclosure is described above in conjunction with FIG. 2. A flowchart of a method 300 for restoring a virtual machine according to an embodiment of the present disclosure will be described below in conjunction with FIG. 3. After the method 200 starts, and then pauses the second virtual machine, the method 300 is performed, and may be implemented by the manager 102 in FIG. 1. For the ease of discussion, the method 300 will be described with reference to FIG. 1. It should be understood that while shown in a particular sequence, some steps of the method 300 may be performed in a sequence different from the shown sequence or be performed in parallel. Some embodiments of the present disclosure are not limited in this respect. In addition, the method 300 described in conjunction with FIG. 1 is merely an example, rather than specifically limiting the method 300.

In block 302, the manager 102 receives a request for restoring a first virtual machine, the request including identifier information of the first virtual machine. There is often an operation of turning off the first virtual machine among operations of the first virtual machine. After the first virtual machine is turned off, a user sends the request for restoring the first virtual machine, to re-use the first virtual machine. In some embodiments, the request includes the identifier information of the first virtual machine. Alternatively or additionally, the request may further include user identifier information. The above examples are merely used for describing some embodiments of the present disclosure, rather than specifically limiting the present disclosure.

In block 304, the manager 102 determines a second virtual machine and a first storage capacity of a first memory of the first virtual machine based on identifier information. After receiving the request, the manager 102 determines the identifier information of the virtual machine included in the request. Based on the identifier information, the manager 102 may find out the second virtual machine corresponding to the identifier information, and the manager 102 may also determine configuration information of the first virtual machine corresponding to the identifier information based on the identifier information, such as the first storage capacity of the first memory of the first virtual machine.

In block 306, the manager 102 adjusts a storage capacity of a second memory of the second virtual machine from a second storage capacity to the first storage capacity. In some embodiments, the process of adjusting the storage capacity is implemented by a memory hot swap technology of the virtual machine. The storage capacity of the second memory may be adjusted to the first storage capacity through the memory hot swap technology.

In some embodiments, the first storage capacity of the first memory of the first virtual machine is greater than the second storage capacity of the second memory of the second virtual machine. The storage capacity of the first virtual machine is a storage capacity set by the user, and the second virtual machine is only pre-generated for restoring the first virtual machine. Thus, the memory of the second virtual machine is set with a smaller storage capacity. Therefore, in order to use the second virtual machine as the first virtual machine, it is necessary to restore the storage capacity of the memory of the second virtual machine to the first storage capacity. The above examples are merely used for describing some embodiments of the present disclosure, rather than specifically limiting the present disclosure.

In block 308, the manager 102 causes the second virtual machine to continue running for use as the first virtual machine. After the storage capacity of the memory of the second virtual machine restores to be the same as the storage capacity of the first virtual machine, the state of the second virtual machine is the same as the state of the first virtual machine that is performing the snapshot operation, thus achieving quickly restoring the first virtual machine.

After receiving the request for restoring the first virtual machine, quickly restoring the first virtual machine is achieved by pausing the second virtual machine and adjusting the size of the memory of the second virtual machine. The virtual machine may be restored by adjusting the size of the memory and preloading the virtual machine, without the need for generating a full-mirror snapshot of the virtual machine (e.g., storing memory and system disk data), but only generating a snapshot file of the system disk. Further, this operation completely avoids the step of reading and writing a disk snapshot file, and accelerates the speed of restoring the virtual machine.

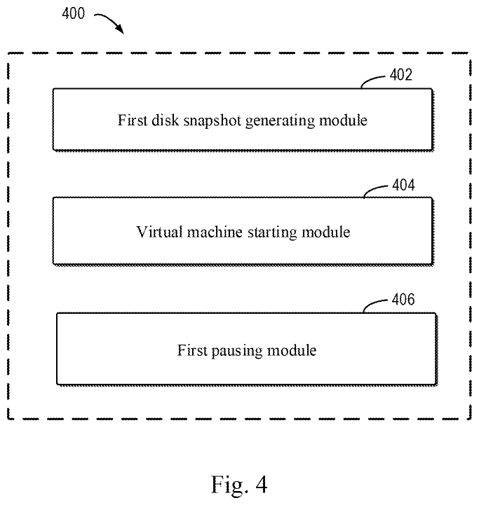

FIG. 4 shows a schematic block diagram of an apparatus 400 for starting a virtual machine according to an embodiment of the present disclosure. The apparatus 400 may be included in the manager 102 of FIG. 1 or be implemented as the manager 102. As shown in FIG. 4, the apparatus 400 includes a first disk snapshot generating module 402 configured to generate a disk snapshot for a first piece of data on a virtual disk of a first virtual machine. The apparatus 400 further includes a virtual machine starting module 404 configured to start running a second virtual machine based on identifier information of the first virtual machine and address information of the disk snapshot, such that the first piece of data is copied to a virtual disk of the second virtual machine. The apparatus 400 further includes a first pausing module configured to pause running the second virtual machine, in response to initialization of an operating system on the started second virtual machine being completed, for restoring the first virtual machine when the first virtual machine is unavailable.

In some embodiments, the first storage capacity of the first memory of the first virtual machine is greater than a second storage capacity of the second memory of the second virtual machine.

In some embodiments, the apparatus 400 further includes a request receiving module configured to receive a request for restoring the first virtual machine, the request including the identifier information of the first virtual machine. The apparatus 400 further includes a storage capacity determining module configured to determine the second virtual machine and the first storage capacity based on the identifier information. The apparatus 400 further includes a storage capacity adjusting module configured to adjust a storage capacity of the second memory of the second virtual machine from the second storage capacity to the first storage capacity. The apparatus 400 further includes a virtual machine running module configured to cause the second virtual machine to continue running for use as the first virtual machine.

In some embodiments, the first disk snapshot generating module includes at least one of the following items: a second disk snapshot generating module configured to generate the disk snapshot in response to receiving a request for generating the disk snapshot; or a third disk snapshot generating module configured to generate the disk snapshot when the first virtual machine is available.

In some embodiments, the first pausing module includes a second pausing module configured to pause running the second virtual machine, in response to receiving indication information indicating completing initialization of the operating system from the second virtual machine.

In some embodiments, the first pausing module includes an initializing module configured to determine initialization of the operating system being completed, in response to monitoring the second virtual machine executing a preset access operation.

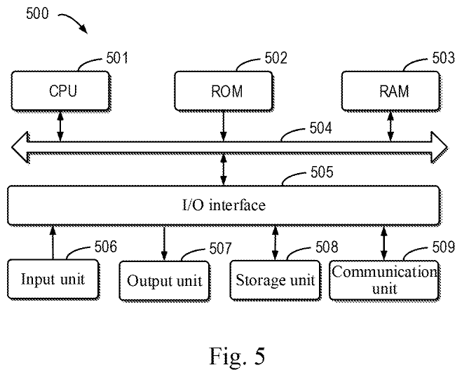

FIG. 5 shows a schematic block diagram of an electronic device 500 that may be used to implement some embodiments of the present disclosure. The device 500 may be used to implement the manager 102 of FIG. 1. As shown in the figure, the device 500 includes a computing unit 501, which may execute various appropriate actions and processes in accordance with computer program instructions stored in a read-only memory (ROM) 502 or computer program instructions loaded into a random access memory (RAM) 503 from a storage unit 508. The RAM 503 may further store various programs and data required by operations of the device 500. The computing unit 501, the ROM 502, and the RAM 503 are connected to each other through a bus 504. An input/output (I/O) interface 505 is also connected to the bus 504.

A plurality of components in the device 500 is connected to the I/O interface 505, including: an input unit 506, such as a keyboard, and a mouse; an output unit 507, such as various types of displayers and speakers; a storage unit 508, such as a magnetic disk, and an optical disk; and a communication unit 509, such as a network card, a modem, and a wireless communication transceiver. The communication unit 509 allows the device 500 to exchange information/data with other devices via a computer network, e.g., the Internet, and/or various telecommunication networks.

The computing unit 501 may be various general purpose and/or special purpose processing components having a processing power and a computing power. Some examples of the computing unit 501 include, but are not limited to, a central processing unit (CPU), a graphics processing unit (GPU), various special purpose artificial intelligence (AI) computing chips, various computing units running a machine learning model algorithm, a digital signal processor (DSP), and any appropriate processor, controller, micro-controller, and the like. The computing unit 501 executes various methods and processes described above, such as the method 200 and the method 300. For example, in some embodiments, the method 200 and the method 300 may be implemented in a computer software program that is tangibly included in a machine readable medium, such as the storage unit 508. In some embodiments, a part or all of the computer program may be loaded and/or installed onto the device 500 via the ROM 502 and/or the communication unit 509. When the computer program is loaded into the RAM 503 and executed by the computing unit 501, one or more steps of the method 200 and the method 300 described above may be executed. Alternatively, in other embodiments, the computing unit 501 may be configured to execute the method 500 by any other appropriate approach (e.g., by means of firmware).

The functions described herein above may be performed, at least in part, by one or more hardware logic components. For example, and without limitation, exemplary types of hardware logic components that may be used include: Field Programmable Gate Array (FPGA), Application Specific Integrated Circuit (ASIC), Application Specific Standard Product (ASSP), System on Chip (SOC), Complex Programmable Logic Device (CPLD), and the like.

Program codes for implementing the method of the present disclosure may be written in any combination of one or more programming languages. These program codes may be provided to a processor or controller of a general purpose computer, special purpose computer or other programmable data processing apparatus such that the program codes, when executed by the processor or controller, enables the functions/operations specified in the flowcharts and/or block diagrams being implemented. The program codes may execute entirely on the machine, partly on the machine, as a stand-alone software package partly on the machine and partly on the remote machine, or entirely on the remote machine or server.

In the context of the present disclosure, the machine readable medium may be a tangible medium that may contain or store programs for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, portable computer disk, hard disk, random access memory (RAM), read only memory (ROM), erasable programmable read only memory (EPROM or flash memory), optical fiber, portable compact disk read only memory (CD-ROM), optical storage device, magnetic storage device, or any suitable combination of the foregoing.

In addition, although various operations are described in a specific order, this should not be understood that such operations are required to be performed in the specific order shown or in sequential order, or all illustrated operations should be performed to achieve the desired result. Multitasking and parallel processing may be advantageous in certain circumstances. Likewise, although several specific implementation details are included in the above discussion, these should not be construed as limiting the scope of the present disclosure. Certain features described in the context of separate embodiments may also be implemented in combination in a single implementation. Conversely, various features described in the context of a single implementation may also be implemented in a plurality of implementations, either individually or in any suitable sub-combination.

Although the embodiments of the present disclosure are described in language specific to structural features and/or method logic actions, it should be understood that the subject matter defined in the appended claims is not limited to the specific features or actions described above. Instead, the specific features and actions described above are merely exemplary forms of implementing the claims.

What is claimed is:

1. A method for starting a virtual machine, comprising:
generating a disk snapshot for a first piece of data on a virtual disk of a first virtual machine;
starting running a second virtual machine based on identifier information of the first virtual machine and address information of the disk snapshot, such that the first piece of data is copied to a virtual disk of the second virtual machine; and
pausing running the second virtual machine, in response to initialization of an operating system on the started second virtual machine being completed, for restoring the first virtual machine when the first virtual machine is unavailable.

2. The method according to claim 1, wherein a first storage capacity of a first memory of the first virtual machine is greater than a second storage capacity of a second memory of the second virtual machine.

3. The method according to claim 2, wherein the method further comprises:
receiving a request for restoring the first virtual machine, the request comprising the identifier information of the first virtual machine;
determining the second virtual machine and the first storage capacity based on the identifier information;
adjusting a storage capacity of the second memory of the second virtual machine from the second storage capacity to the first storage capacity; and
causing the second virtual machine to continue running for use as the first virtual machine.

4. The method according to claim 1, wherein the generating a disk snapshot for a first piece of data on a virtual disk of a first virtual machine comprises at least one of:
generating the disk snapshot in response to receiving a request for generating the disk snapshot; or
generating the disk snapshot when the first virtual machine is available.

5. The method according to claim 1, wherein the pausing running the second virtual machine comprises:
pausing running the second virtual machine, in response to receiving indication information indicating completing initialization of the operating system from the second virtual machine.

6. The method according to claim 1, wherein the pausing running the second virtual machine comprises:
determining initialization of the operating system being completed, in response to detecting the second virtual machine executing a preset access operation.

7. An apparatus for starting a virtual machine, comprising:
at least one processor; and
a memory storing instructions, wherein the instructions when executed by the at least one processor, cause the at least one processor to perform operations, the operations comprising:
generating a disk snapshot for a first piece of data on a virtual disk of a first virtual machine;
starting running a second virtual machine based on identifier information of the first virtual machine and address information of the disk snapshot, such that the first piece of data is copied to a virtual disk of the second virtual machine; and
pausing running the second virtual machine, in response to initialization of an operating system on the started second virtual machine being completed, for restoring the first virtual machine when the first virtual machine is unavailable.

8. The apparatus according to claim 7, wherein a first storage capacity of a first memory of the first virtual machine is greater than a second storage capacity of a second memory of the second virtual machine.

9. The apparatus according to claim 8, wherein the operations further comprise:
receiving a request for restoring the first virtual machine, the request comprising the identifier information of the first virtual machine;
determining the second virtual machine and the first storage capacity based on the identifier information;
adjusting a storage capacity of the second memory of the second virtual machine from the second storage capacity to the first storage capacity; and
causing the second virtual machine to continue running for use as the first virtual machine.

10. The apparatus according to claim 7, wherein the generating a disk snapshot for a first piece of data on a virtual disk of a first virtual machine comprises at least one of:
generating the disk snapshot in response to receiving a request for generating the disk snapshot; or
generating the disk snapshot when the first virtual machine is available.

11. The apparatus according to claim 7, wherein the pausing running the second virtual machine comprises:
pausing running the second virtual machine, in response to receiving indication information indicating completing initialization of the operating system from the second virtual machine.

12. The apparatus according to claim 7, wherein the pausing running the second virtual machine comprises:
determining initialization of the operating system being completed, in response to detecting the second virtual machine executing a preset access operation.

13. A non-transitory computer readable storage medium, storing a computer program thereon, wherein the program, when executed by a processor, causes the processor to perform operations, the operations comprising:
generating a disk snapshot for a first piece of data on a virtual disk of a first virtual machine;
starting running a second virtual machine based on identifier information of the first virtual machine and address information of the disk snapshot, such that the first piece of data is copied to a virtual disk of the second virtual machine; and
pausing running the second virtual machine, in response to initialization of an operating system on the started second virtual machine being completed, for restoring the first virtual machine when the first virtual machine is unavailable.
